(19) United States
(12) Patent Application Publication
(10) Pub. No.: US 2007/0095255 A1
(43) Pub. Date: May 3, 2007

(54) Blended cement composition

(76) Inventors: William V. Abbate, Valencia, PA (US); Daniel F. Mueller, Hummelstown, PA (US)

Correspondence Address: BUCHANAN INGERSOLL & ROONEY PC, P.O. BOX 1404, ALEXANDRIA, VA, 22313-1404, US

(21) Appl. No.: 11/588,462

(22) Filed: Oct. 27, 2006

Related U.S. Application Data
(60) Provisional application No. 60/731,035, filed on Oct. 28, 2005.

(51) Int. Cl. C04B 28/04; C04B 7/19; C04B 7/00; C04B 40/00

(52) U.S. Cl. 106/713; 106/714; 106/737; 106/819

(57) ABSTRACT

A blended cement composition including portland cement, slag, and one or more additives is included herein. Also included herein is a supplementary cementitious material including slag. Slags used herein may have low amorphous content and may provide beneficial particle packing and durability properties when provided in combination with portland cement and/or other pozzolans.

### CROSS-REFERENCE TO RELATED APPLICATIONS

This application claims priority to pending U.S. Provisional Patent Application No. 60/731,035, filed on Oct. 28, 2005. That application is incorporated by reference herein.

### FIELD OF THE INVENTION

The present invention is directed toward supplementary cementitious materials and blended cement compositions that include slag and, more particularly, toward a supplementary cementitious material (“SCM”) comprising a slag having pozzolanic characteristics. Compositions of the invention may include additional pozzolans and other additives.

### BACKGROUND OF THE INVENTION

Concrete mixtures typically incorporate portland cement. Portland cements are hydraulic cements that chemically react and harden with the addition of water. Portland cement typically includes a blend of iron, clay, and cement rock/limestone, which is heated to a temperature of about 2,600-3,000° F. After heating, the portland cement is typically ground to a powder, and may be mixed with components, such as gypsum, to control setting time. Portland cement is typically utilized as a component in concrete mixtures for a variety of construction applications.

There is a growing trend to try and develop a lower cost cementitious mixture that either reduces or eliminates the dependency on portland cement, i.e., iron, clay, and cement rock/limestone. This dependency may be reduced, for example, by providing a composition that may be mixed with portland cement yet still provide beneficial or enhanced properties of portland cement. There is further a concern that portland cement production releases a large amount of greenhouse gases, and it would be desirable to formulate a more environmentally-friendly product that requires less portland cement.

### SUMMARY OF THE INVENTION

An embodiment of the invention provides a supplementary cementitious material comprising about 25% to about 80% of slag, by weight, about 20% to about 75% other pozzolans, and about 0% to about 25% other additives. In further embodiments of the invention the amount of slag provided is between about 30% to about 75%, about 35% to about 70%, about 40% to about 65%, or about 45% to about 60%, the amount of pozzolans is between about 25% to about 70%, about 30% to about 65%, about 35% to about 60%, or about 40% to about 55%, and the amount of other additives is about 5%, about 10%, about 15%, about 20%, or about 25%. Embodiments of the invention may include additives. They may also include calcium oxide and/or calcium hydroxide.

Other pozzolans used in embodiments of the invention may be one or more of silica fume, metakaolin, ASTM C 618 Class C fly ash, ASTM C 618 Class F fly ash, ASTM C 618 Class N pozzolan, rice hull ash, silica flour, ground granulated blast furnace slag, and other pozzolans known to those of skill in the art. Other pozzolans may be present in different amounts in different embodiments of the invention. For example, in embodiments of the invention silica fume is present in an amount between 0.0 and 20% by weight, metakaolin is present in an amount between 0.0 to 20% by weight, Class C fly ash is present in an amount between 0.0 to 60% by weight, Class F fly ash is present in an amount between 0.0 to 60% by weight, Class N pozzolan is present in an amount between 0.0 to 60% by weight, ground granulated blast furnace slag is present in an amount between 0.0 to 60% by weight, rice hull ash is present in an amount between 0.0 to 60% by weight, and silica flour is present in an-amount between 0.0 to 20% by weight.

Slag used in embodiments of the invention may be alloy steel slag and/or steel slag. One slag that may be used is stainless steel slag. Slags used in the invention may have, for example, a metal content less than about 10%. Slags may also have between about 20-50%, about 25-45%, or about 30-40% amorphous content as measured by X-ray diffraction. A further embodiment provides a supplementary cementitious material wherein at least 22% of the material has a particle size greater than 68 μm and less than 420 μm.

Another embodiment provides a cement composition comprising about 5 to 50% of the supplementary cementitious material described herein and about 50% to about 90% of portland cement.

A further embodiment of the invention provides supplementary cementitious material comprising slag, wherein at least 20% of the material has a particle size greater than 68 μm and less than 420 μm. In a further embodiment at least 16% of the material has a particle size greater than 80 μm and less than 418 μm. In a yet still further embodiment at least 14% of the material has a particle size greater than 90 μm and less than 418 μm.

### DESCRIPTION OF THE FIGS.

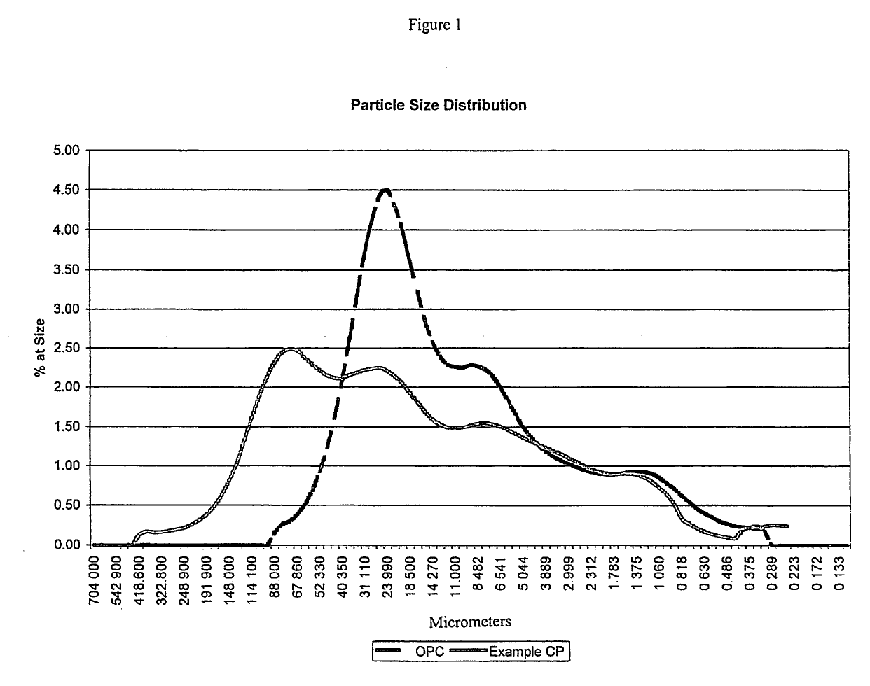

FIG. 1 provides a comparison of particle size distribution of one supplementary cementitious material of the invention with particle size distribution of a sample of ordinary portland cement.

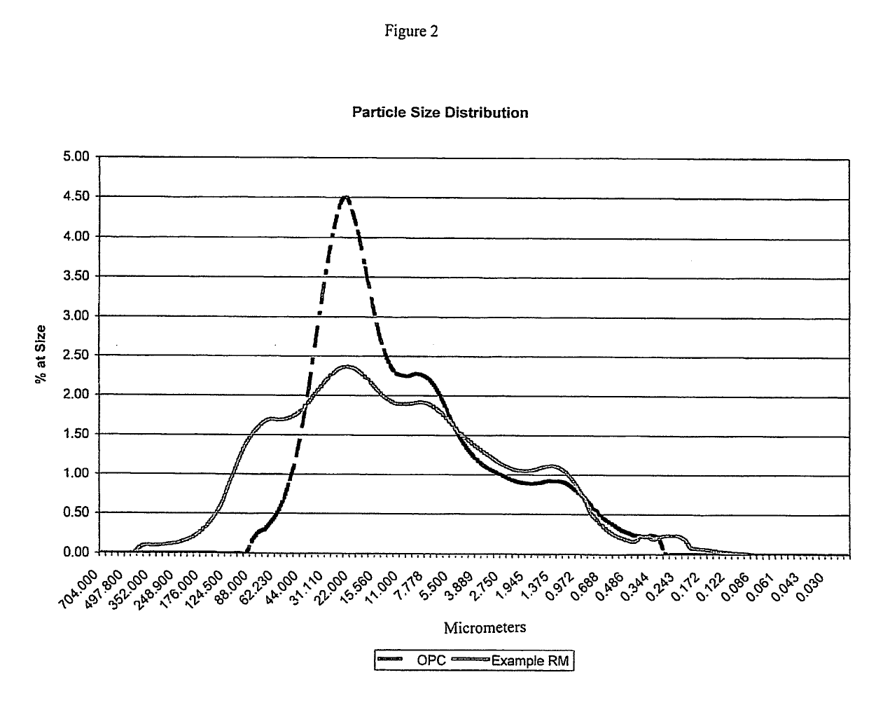

FIG. 2 provides a comparison of particle size distribution of a further embodiment of supplementary cementitious material with the particle size distribution of a sample of ordinary portland cement.

### DESCRIPTION OF THE INVENTION

Slag is offered as a material to be incorporated into portland cement to provide a viable portland cement SCM. As used herein, “slag” and “slags” refer to steel slags and alloy steel slags, but does not include blast furnace slag. Preferred slags have low amorphous content. Different slags may be combined with each other and/or with blast furnace slag and other furnace slags as a substitute for portland cement in cementitious materials. These slags may offer increased strength and durability characteristics in concrete and resulting products. Further, provided herein is an advantageous way to make beneficial use of slag that might otherwise be disposed of.

The blended cement composition of the present invention is intended to beneficiate slag by enhancing its pozzolanic characteristics through blending with any portland cement and other pozzolans. Formulations have been developed herein for making a blended cement product that, when used, will improve the performance and durability of concrete mixtures greater than that obtained using conventional hydraulic cements, such as portland cement, alone or mixed with supplementary cementitious materials. Desirable characteristics, or properties, of a more durable cement product are as follows:
Having a less porous structure obtained through a higher cementibinder particle packing characteristics forming a more dense microstructure.
Reduced chloride-ion penetration.
Less cracking under sulfate attack.

In addition to durability concerns, it is desired herein to obtain a blended cement product having improved product performance, which can be defined according to the following properties:
Improved 28 day and longer strengths.
Lower evidence of efflorescence.

Slags are a by-product of the steel-making process. The production of alloy steel requires that certain alloying elements must be added to, and made part of, a molten steel composition.

Impurities resulting from the added alloying elements, and any impurities present in the molten steel composition, are removed from the steel production furnace to produce a commercial grade alloy steel. Impurities may include, for example, one or more of nickel, manganese, carbon, and chromium. The resulting steel slags comprise the impurities from the steel and/or additional alloying elements removed as by-products from the steel production furnace. The slag typically occurs as a molten liquid melt and is a complex solution of silicates, oxides, and a small percentage of metallics that solidify upon cooling. A preferred slag for use in embodiments of the invention is stainless steel slag.

“Ready-mix” as used in the invention, refers to a concrete product that is designed to be made in a factory and delivered to a worksite. “Blends” refer to supplementary cementitious materials of the invention mixed with portland cement. Blends of the invention may include admixtures.

Slags used in the invention may be demineralized slags from which all or part of the metal waste has been removed. Removal of metal waste may be accomplished, for example, by a grinding step followed by a removal step. The removal step may be, for example, gravity separation, size separation, or magnetic separation.

Slags typically contain an ambient moisture content. For example, this moisture content may be between about 15% to about 20%. That moisture content may be reduced prior to mixture of the slag with other pozzolans. For example, it may be reduced to below about 5% or below about 1%. Moisture reduction (drying) may be done by any method known to those skilled in the art.

Slag may comprise silicates, oxides and other compounds of calcium, silicon, magnesium, iron, aluminum, manganese, titanium, sulfur, chromium and nickel. For example, slag may comprise calcium silicate and/or calcium oxide. In one embodiment, slag may comprise from about 80 to about 99 weight percent calcium silicate. A typical slag composition may comprise from about 0.2 weight percent to about 50 weight percent Ca; from about 0.5 weight percent to about 65 weight percent Si; from about 0.1 weight percent to about 5 weight percent Mg; from about 0.1 weight percent to about 6 weight percent Fe; from about 1 weight percent to about 40 weight percent Al; from about 0.1 weight percent to about 1 weight percent Mn; from about 0.1 weight percent to about 0.5 weight percent Ti; from about 0.01 weight percent to about 2.5 weight percent S; from about 0.3 weight percent to about 5 weight percent Cr; and from about 0.01 weight percent to about 1 weight percent Ni. In another embodiment, slag may comprise 30 weight percent Ca; 12 weight percent Si; 7 weight percent Mg; 4 weight percent Fe; 3 weight percent Al; 1 percent Mn; 0.5 weight percent Ti; 0.2 weight percent Cr; and 0.04 weight percent Ni.

Slag with a low level of amorphous content is preferred. For example, slags used in the invention may have an amorphous content, measured by X-ray diffraction, of between about 20% to about 60%; about 25% to about 55%; about 27.6% to about 50.5%; about 30% to about 50%; about 35% to about 50%; about 40% to about 50%, or about 45%.

Slag may be cooled and processed to provide it in relatively fine particulate form. If desired, grinding or milling may be used to reduce the particle size of the slag, e.g., to a size approximating the particle size of portland cement. In one embodiment, slag has an average particle size of from about 100% passing through a 200 mesh screen to about 45% passing through a 325 mesh screen. In another embodiment, slag has an average particle size of from about 80% passing through a 325 mesh screen to about 95% passing through a 325 mesh screen. In yet another embodiment, slag has an average particle size of less than about 100 micrometers. In still another embodiment, slag has an average particle size of from about 1 micrometer to about 50 micrometers. The slag may be provided in the form of a gray powder having a typical specific gravity of about 2.8.

Slag can additionally be characterized as that slag obtained from a production of steel or alloy steel having been processed by a size reduction to at least about 40%, at least about 50%, at least about 60%, at least about 70%, at least about 80%, at least about 90%, or at least about 95% passing through a 325 mesh screen, with a preferred range of 95% or more passing through a 325 mesh screen, and drying following the recovery of the metallic components. Typically, 80% or better of the metallic components will have been recovered from the slag, however, other recovery percentages are also contemplated herein. For example, the slag may contain about 10%, about 9%, about 8%, about 7%, about 6%, about 5%, about 4%, about 3%, about 2%, about 1%, or less than about 1% metal.

Slag can further be characterized in chemical terms as the de-metalized residual fluxing material occurring as a by-product from the steel production. The slag is typically comprised primarily of silicates of calcium, magnesium, aluminum and iron, with a total silicate concentration typically between 70 and 95%.

Alternatively, slag can be characterized in terms of oxide analysis, with the principal cement components of calcium, silicon and aluminum. Typical oxide analysis includes weight percentages of calcium from about 1 to 50%, silicon from about 1 to 30% and aluminum from about 0.5 to 15%.

In its most general form, the blended cement composition of the present invention includes portland cement (or other hydraulic cement), slag, and supplementary cementitious materials such as fly ash or naturally occurring calcined pozzolans. Non-granulated blast furnace slag may additionally be substituted, either entirely or partially, for the slag. In one embodiment, the composition of the blended cement product comprises, by weight:
Portland cement (50-95% of total, preferably 75-85% of total, more preferably 80% of total);
A mixture of slag and other pozzolans (5-50% of total, preferably 15-25% of total, most preferably 20% of total), which comprises:
Slag (40-100% of slag/pozzolan mixture, preferably 40-80%, most preferably 50-70%);

and one or more of the following ingredients, in the listed amounts:
Silica fume (0.0 to 20%);
Metakaolin (0.0 to 20%);
ASTM C 618 Class C and/or Class F fly ash and/or Class N pozzolan (0.0 to 60%);
Ground granulated blast furnace slag (0.0 to 60%);
Rice Hull Ash (0.0 to 60%);
Silica Flour (0.0 to 20%).

In a further embodiment a blended composition includes about 0.0 to 30% other additives. These additives may be, for example, any of those known to be beneficial to those in the cement-making arts. For example, calcium oxide and/or calcium hydroxide may be added.

The process involved in the manufacturing of the blended cement product and supplementary cementitious material of the present invention is a combination of the metal recovery process, producing a usable raw material described herein as slag, and the drying and blending of the various components. Blending may be conducted by any suitable method known to one of skill in the art. For example, in one embodiment the assembled components are blended in a high energy mixer until thoroughly mixed. The order of addition of the ingredients is not important.

A very important aspect of the metal recovery operation is the final gradation process of the slag that has been de-metalized. Through the utilization of proper controls, the slag can be properly separated by size, producing the desired performance in the final blended cement product. The slag can also be simply ground to the desired size. Additionally, the process of drying the slag to a usable moisture content remains an important aspect of the processing in accordance with the present invention. Further, following proper methods of blending the various components, the manufacturing process will be complete.

In embodiments presented herein, a blended cement product with a hydraulic cement component is provided. One examplary hydraulic cement component is portland cement. The hydraulic cement component should produce sufficient excess calcium hydrate upon mixing with water to react with the slag and other supplementary cementitious materials in the blended cement product to form hydration products of aluminates and silicates. The hydraulic cement product should be in the final blended product of at least 50%, with the remainder of the blended cement product comprised of slag and other supplementary cementitious materials and additives. Numerous embodiments of the invention are contemplated herein to obtain durable concrete mixes based upon the demands of differing marketplace segments.

In one embodiment, the blended cement product of the present invention can include the following composition: 50-85% portland cement; 10-30% slag; 0-5% ground granulated blast furnace slag; 1-18% fly ash; 0-15% metakaolin; 0-15% silica fume; and 0-10% calcium oxide.

In one currently preferred aspect of the present invention, which has been found to achieve desired durability and performance characteristics, a blended cement product has been developed which has the following components, listed by their weight percentages (approximately): portland cement 70%; slag 20%; metakaolin 1%; Class C fly ash 6.5%; silica fume 0.5%; and calcium oxide 2%.

Upon mixing the blended cement product with water and aggregates, a highly durable concrete mixture can be produced. Achieving desired durability characteristics is not just a factor of blend mix designs, but the inclusion of raw ingredients. For example, the addition of slag will increase the particle packing in the concrete matrix, thus lowering permeability and increasing chemical resistance to chemical attack. The addition of silica fume and metakaolin, which are strong pozzolans, also reduce porosity and will react with the calcium in the concrete matrix to lessen the chance of the calcium reacting with other materials that could cause cracking or other deterioration. By proper selection of the composition of the blended cement product, the following durability characteristics can be achieved:
Greater efflorescence control.
Lower porosity concrete.
Higher ASR (alkali-silica reactivity) resistance.
Lower chloride-ion penetration.
Improved color retention.
Improved strength.

Although regulatory compliance or lack thereof shall not be construed to limit the claims, it should be noted that blends of the invention typically conform to ASTM International standards. Standards that may be conformed to include ASTM C 1157 and ASTM C595.

Efflorescence results from the excess or un-reacted calcium, generated in the production of standard portland concrete products, migrating, over time, to the surface of the concrete and being deposited as a white precipitate on the surface creating an unpleasant visual appearance. In one embodiment, certain components of the blended cement product react with any excess calcium hydrate in the product, thereby minimizing efflorescence.

By lowering the porosity of the concrete, durability of the end product will result by limiting the migration of water, and any soluble contaminants, into the product. Numerous embodiments can include the use of specifically graded slags and supplementary cementitious materials to generate a greater particle distribution allowing for a more dense cement paste structure.

Alkali silica reactivity (ASR) directly relates to durability, in that the reaction of silica in the aggregate can form an expansive product when reacted with the cement causing deterioration of the concrete. Silica compounds in a concrete mix are largely introduced from the aggregate selected for use in the concrete product. Silica compounds that come from the aggregates used to make concrete products are subject to dissolution and reaction within any free calcium hydroxide ions present in the basic solutions, forming a silica gel which can swell, causing product deterioration and lowering durability. Some embodiments reduce the excess calcium, as indicated above, to minimize the potential for silica gel formation, thus enhancing durability.

Chloride ions that are dissolved in water through the addition of de-icing salts may enter the pore spaces of the concrete product and can alter the freeze-thaw characteristics of the product, thus increasing the likelihood of crack formation, or other deterioration, and premature product failure. Embodiments of the invention can include a high particle packing mixture that will reduce concrete porosity, limiting access to water soluble chloride attack.

Color pigments used in concrete that are exposed to sunshine may, over a short period of time, lose some of their original color properties, lessening the desirability and finish of the final product. The embodiments of the invention may include the increased use of supplementary cementitious materials that have the ability to reduce sun bleaching of pigmented concrete products.

Based on the teachings herein, one skilled in the art can design a blended cement product in accordance with the present invention to achieve desired durability and performance characteristics for a desired application. Particular embodiments of the present invention have been described above for purposes of illustration only. It will be evident to one of ordinary skill in the art that numerous variations of the details of the present invention can be obtained without departing from the spirit and scope of the present invention.

### EXAMPLES

The following examples are intended to guide those skilled in the art in the practice of this invention. They should not be construed to limit the scope of the invention, which is defined by the claims.

### Example 1

### Compositions A & B

Example 1 describes creation and testing of two embodiments of the invention and a control, as shown in Table 1. The control is Type I portland cement as defined by ASTM C-150. To form the compositions of Composition A and Composition B, both of which are concrete products, demineralized stainless steel slag containing ambient moisture (15-20%) was dried to about 1% moisture (by weight). Dried slag was mixed with the remaining pozzolans (metakaolin, Class C fly ash, and Silica Fume) at the amounts listed. The percentages of slag and pozzolans given in Table 1 are percentages of the Slag Blend by weight. The percentages of metakaolin, Class C ash, and silica fume are percentages of the pozzolans by weight.

Compression and percent absorption tests were conducted on the control, Composition A, and Composition B, using ASTM C-140 standards. As seen in Table 1, Compositions A and B showed improved strength when compared to the control at all product ages. Absorption data implies a finer microstructure with a lower porosity than the control.

### Example 2

### Compositions C and D

Example 2 describes creation and testing of two further embodiments of the invention and a control, as shown in Table 2. Compositions C and D are “ready mix” compositions. Slump was measured using ASTM 143. Pozzolan content in Compositions C and D is stainless steel slag—25%; ground granulated blast furnace slag—22%; Class C fly ash—52%; and silica fume 1%. The average particle size of Composition D was less than that of Composition C. Results of compression testing for Compositions C and D in comparison to a control show lower strength results at early stages and equivalent or greater strengths at 28 days. All strength results exceed ASTM C 1157 and ASTM C 595 requirements.

### Example 3

### Particle Size Distribution

FIG. 1 provides a particle size distribution comparing a supplementary cementitious material (Composition A) with a typical particle distribution of ordinary portland cement (OPC). Data used to generate FIG. 1 is provided in Table 3. The concrete products example demonstrates a more even distribution than OPC. This allows greater particle packing.

FIG. 1 also shows that the provided embodiment of the invention has a larger particle size in the 88 to 418 micrometer size range. This provides a gap filling effect between the cement paste and fine sand fraction of a concrete product that may be created. One such product is a concrete paver. Gap filling adds strength to the product and reduces product porosity.

FIG. 2 provides a particle size distribution comparing particle size distribution for a ready-mix embodiment of the invention (Composition C) with that of a typical OPC. Data used to generate FIG. 2 is provided in Table 3. This embodiment gives a broad distribution of product particle sizes extending to a 352 micrometer diameter. This allows increased particle packing compared to OPC, which lowers porosity and increases early 1-3 day strength. This is in contrast to typical pozzolan addition; for example, addition of fly ash alone does not provide this benefit. Dominant particle size is similar to that of OPC, but greater overall distribution results in better packing.

### Example 4

### Raw Chemistry

Example 4 describes chemical analysis of raw ingredients used in formulation of product blends used in some embodiments of the inventions. Table 4 provides X-ray fluorescence (XRF) data for multiple compositions of the invention, blends A-C. Table 5 provides X-ray diffraction (XRD) and XRF analysis for individual blend components. XRD analysis detects crystalline material chemistry but does not detect amorphous chemistry; XRD data is provided herein primarily to show the amount of amorphous and crystalline material in a sample. XRF analysis provides elemental (and oxide chemistry by calculation) analysis. XRF analysis allows estimate of reactivity indexes for blended cements.

Table 4 shows an OPC with as little as 22.7% amorphous content, though an amorphous content as high as 45% has been reported. Most active pozzolans (including ground granulated blast furnace slag) contain amorphous content greater than 70%. As shown in Table 4, slow-cooled slags may have an amorphous content from about 20% to greater than 50%.

XRF data analysis for pozzolan activity pursuant to ASTM C 618 focuses largely on silicon (SiO2), aluminum (Al2O3), and iron (Fe2O3). ASTM C 618 lists requirements for amounts of these compounds to allow sufficient activity with OPC. In particular, ASTM C 618 requires that pozzolans include at least 50% total silicon, aluminum, and iron content.

Based on this data, it appears that for a slag/portland cement blend to satisfy ASTM C 618, the blend should include at least one other pozzolan to provide the necessary amorphous content. If compliance with ASTM C 618 or another standard (for example, a Department of Transportation standard) is not necessary, then no additional pozzolan needs to be included.

### Example 5

### Blend Chemistry

Incorporating slag and other pozzolans into portland cement according to embodiments of the invention allows one to obtain a desired calcium, iron, aluminum, and silicon chemistry for different applications. Performance analysis of blends of embodiments of the invention may be done using “Bogue calculations,” which are known to those of skill in the art. Bogue calculations allow estimation of the primary compounds in cement as tricalcium silicate (Ca3SiO5 or “C3S”), dicalcium silicate (Ca2SiO4 or “C2S”), tricalcium aluminate (Ca6Al2O6 or “C3A”), and tetracalcium alumino ferrite (Ca4Al2Fe2O10 or “C4AF”).

Results of Bogue calculations for concrete products embodiments (Compositions A and B) and ready-mix embodiments (Compositions C and D) of the invention are shown in Table 6. Table 6 also includes calculations for individual pozzolans, which may be used as either cementitious binders or in combination with OPC. Bogue calculations show that ground granulated blast furnace slag (GGBFS) has a significantly different profile than non-GGBFS slag, which indicates that binding properties are also significantly different.

Whereas particular embodiments of this invention have been described for purposes of illustration, it will be evident to those persons skilled in the art that numerous variations of the details of the present teaching may be made without departing from the invention as defined in the appended claims. Those patents and publications discussed herein should be viewed as indicative of the level of skill in the art, though no admission is made that any document is a prior art reference. All of the foregoing patents and publications discussed herein, including but not limited to the ASTM standards that are discussed, are hereby incorporated by reference.

TABLE 1

| | Mix ID | | |
|---|---|---|---|
| | 29 | 30 | 31 |
| Mix Description | Control | Composition A | Composition B |
| Portland Cement/Slag Blend | | 80/20 | 80/20 |
| Ratio | | | |
| Cement (lbs.) | 8.57 | 6.84 | 6.70 |
| Slag Blend (lbs.) | 0 | 1.71 | 1.67 |
| Slag (as % Slag Blend) | | 66.67 | 66.67 |
| Pozzolans (as % Slag Blend) | | 33.33 | 33.33 |
| Metakaolin (as % Pozzolans) | | 10% | 10% |
| C-Ash (as % Pozzolans) | | 85% | 85% |
| Silica Fume (as % Pozzolans) | | 5.00% | 5.00% |
| w/c Ratio | 0.40 | 0.40 | 0.40 |
| Raw Mix (%) Moisture | 6.3 | 6.80 | 7.90 |
| Total Agg/Cmt. Weight (lbs) | 60.44 | 60.35 | 60.35 |

Compression Test Results (avg)

| Days | % of Control | | | | |
|---|---|---|---|---|---|
| 1 | 3200 | 3690 | 115 | 3360 | 105 |
| 7 | 3360 | 4510 | 134 | 4410 | 131 |
| 28 | 4280 | 4910 | 115 | 5070 | 118 |
| % Absorption | 9.3 | 7.0 | | 6.98 | |

TABLE 2

| | Mix I.D. | | |
|---|---|---|---|
| | 120 | 121 | 122 |
| Mix Description | Control Mix | Composition C | Composition D |
| Cement (lbs/yd³) | 517 | 414 | 414 |
| Slag - GGBFS - Ash - | 0 | 103 | 103 |
| Silica Fume | | | |
| w/c Ratio | 0.60 | 0.57 | 0.56 |
| Slump (in.) | 4.5 | 4 | 4.5 |
| (%) Air | 2.20% | 2.50% | 2.30% |
| Mix Temperature | 67.0° F. | 67.6° F. | 67.4° F. |
| Total Batch Weight (lbs) | 187.49 | 186.97 | 186.97 |
| Design Batch Size (ft³) | 1.25 | 1.25 | 1.25 |
| Unit Weight (lbs/ft³) | 150.4 | 150.4 | 149.8 |
| Actual Yield (ft³) | 1.247 | 1.243 | 1.248 |
| Corrected Cement | 518 | 416 | 415 |
| Content/Yd³ | | | |
| Corrected Blend | 0 | 104 | 103 |
| Content/Yd³ | | | |

Compression Test Results (avg.)

| | Days | | | | |
|---|---|---|---|---|---|
| | | | 121 | | 122 |
| 4 × 8 cylinders | | | % of Control | | % of Control |
| 1 | 1700 | 1340 | 79 | 1330 | |
| 3 | 2810 | 2190 | 78 | 2410 | 78 |
| 7 | 3600 | 3360 | 93 | 3470 | 86 |
| 14 | 4340 | 4060 | 94 | 4290 | 96 |
| 28 | 5080 | 5090 | 100 | 5290 | 99 |
| | | | | | 104 |

Notes/Comments:
Admixture used - Plastocrete 161 for all tests

TABLE 3

| | | | | | Example | Exam- |
|---|---|---|---|---|---|---|
| | | OPC (Control) | | | CP | ple RM |
| Channel | | % in | % | Channel | % in | % in |
| edge (μm) | inch | channel | passing | edge | channel | channel |
| 704.000 | 0.027717 | 0.00 | 100.00 | 704.000 | 0.00 | 0.00 |
| 645.600 | 0.025417 | 0.00 | 100.00 | 645.600 | 0.00 | 0.00 |
| 592.000 | 0.023307 | 0.00 | 100.00 | 592.000 | 0.00 | 0.00 |
| 542.900 | 0.021374 | 0.00 | 100.00 | 542.900 | 0.00 | 0.00 |
| 497.800 | 0.019598 | 0.00 | 100.00 | 497.800 | 0.00 | 0.00 |
| 456.500 | 0.017972 | 0.00 | 100.00 | 456.500 | 0.00 | 0.00 |
| 418.600 | 0.016480 | 0.00 | 100.00 | 418.600 | 0.13 | 0.08 |
| 383.900 | 0.015114 | 0.00 | 100.00 | 383.900 | 0.17 | 0.10 |
| 352.000 | 0.013858 | 0.00 | 100.00 | 352.000 | 0.16 | 0.10 |
| 322.800 | 0.012709 | 0.00 | 100.00 | 322.800 | 0.17 | 0.10 |
| 296.000 | 0.011654 | 0.00 | 100.00 | 296.000 | 0.18 | 0.11 |
| 271.400 | 0.010685 | 0.00 | 100.00 | 271.400 | 0.20 | 0.12 |
| 248.900 | 0.009799 | 0.00 | 100.00 | 248.900 | 0.22 | 0.13 |
| 228.200 | 0.008984 | 0.00 | 100.00 | 228.200 | 0.26 | 0.16 |
| 209.300 | 0.008240 | 0.00 | 100.00 | 209.300 | 0.31 | 0.19 |
| 191.900 | 0.007555 | 0.00 | 100.00 | 191.900 | 0.39 | 0.23 |
| 176.000 | 0.006929 | 0.00 | 100.00 | 176.000 | 0.49 | 0.30 |
| 161.400 | 0.006354 | 0.00 | 100.00 | 161.400 | 0.63 | 0.38 |
| 148.000 | 0.005827 | 0.00 | 100.00 | 148.000 | 0.81 | 0.49 |
| 135.700 | 0.005343 | 0.00 | 100.00 | 135.700 | 1.03 | 0.62 |
| 124.500 | 0.004902 | 0.00 | 100.00 | 124.500 | 1.33 | 0.83 |
| 114.100 | 0.004492 | 0.00 | 100.00 | 114.100 | 1.61 | 1.02 |
| 104.700 | 0.004122 | 0.00 | 100.00 | 104.700 | 1.89 | 1.23 |
| 95.960 | 0.003778 | 0.00 | 100.00 | 95.960 | 2.13 | 1.39 |
| 88.000 | 0.003465 | 0.16 | 100.00 | 88.000 | 2.32 | 1.51 |
| 80.700 | 0.003177 | 0.26 | 99.84 | 80.700 | 2.44 | 1.61 |
| 74.000 | 0.002913 | 0.30 | 99.58 | 74.000 | 2.49 | 1.68 |
| 67.860 | 0.002672 | 0.39 | 99.28 | 67.860 | 2.47 | 1.71 |
| 62.230 | 0.002450 | 0.51 | 98.89 | 62.230 | 2.38 | 1.70 |
| 57.060 | 0.002246 | 0.69 | 98.38 | 57.060 | 2.30 | 1.70 |
| 52.330 | 0.002060 | 0.93 | 97.69 | 52.330 | 2.22 | 1.72 |
| 47.980 | 0.001889 | 1.24 | 96.76 | 47.980 | 2.15 | 1.76 |
| 44.000 | 0.001732 | 1.63 | 95.52 | 44.000 | 2.12 | 1.83 |
| 40.350 | 0.001589 | 2.09 | 93.89 | 40.350 | 2.11 | 1.91 |
| 37.000 | 0.001457 | 2.63 | 91.80 | 37.000 | 2.16 | 2.02 |
| 33.930 | 0.001336 | 3.18 | 89.17 | 33.930 | 2.19 | 2.12 |
| 31.110 | 0.001225 | 3.70 | 85.99 | 31.110 | 2.22 | 2.21 |
| 28.530 | 0.001123 | 4.13 | 82.29 | 28.530 | 2.24 | 2.29 |
| 26.160 | 0.001030 | 4.43 | 78.16 | 26.160 | 2.25 | 2.35 |
| 23.990 | 0.000944 | 4.50 | 73.73 | 23.990 | 2.21 | 2.37 |
| 22.000 | 0.000866 | 4.31 | 69.23 | 22.000 | 2.14 | 2.36 |
| 20.170 | 0.000794 | 4.01 | 64.92 | 20.170 | 2.05 | 2.31 |
| 18.500 | 0.000728 | 3.61 | 60.91 | 18.500 | 1.92 | 2.24 |
| 16.960 | 0.000668 | 3.23 | 57.30 | 16.960 | 1.81 | 2.16 |
| 15.560 | 0.000613 | 2.86 | 54.07 | 15.560 | 1.69 | 2.07 |
| 14.270 | 0.000562 | 2.58 | 51.21 | 14.270 | 1.59 | 1.99 |
| 13.080 | 0.000515 | 2.39 | 48.63 | 13.080 | 1.53 | 1.94 |
| 12.000 | 0.000472 | 2.29 | 46.24 | 12.000 | 1.49 | 1.90 |
| 11.000 | 0.000433 | 2.26 | 43.95 | 11.000 | 1.49 | 1.90 |
| 10.090 | 0.000397 | 2.25 | 41.69 | 10.090 | 1.49 | 1.90 |
| 9.250 | 0.000364 | 2.28 | 39.44 | 9.250 | 1.52 | 1.91 |
| 8.482 | 0.000334 | 2.27 | 37.16 | 8.482 | 1.54 | 1.92 |
| 7.778 | 0.000306 | 2.23 | 34.89 | 7.778 | 1.55 | 1.90 |
| 7.133 | 0.000281 | 2.14 | 32.66 | 7.133 | 1.53 | 1.86 |
| 6.541 | 0.000258 | 2.00 | 30.52 | 6.541 | 1.51 | 1.80 |
| 5.998 | 0.000236 | 1.83 | 28.52 | 5.998 | 1.46 | 1.72 |
| 5.500 | 0.000217 | 1.66 | 26.69 | 5.500 | 1.41 | 1.64 |
| 5.044 | 0.000199 | 1.50 | 25.03 | 5.044 | 1.36 | 1.55 |
| 4.625 | 0.000182 | 1.37 | 23.53 | 4.625 | 1.32 | 1.48 |
| 4.241 | 0.000167 | 1.27 | 22.16 | 4.241 | 1.27 | 1.41 |
| 3.889 | 0.000153 | 1.19 | 20.89 | 3.889 | 1.23 | 1.35 |
| 3.566 | 0.000140 | 1.12 | 19.70 | 3.566 | 1.19 | 1.29 |
| 3.270 | 0.000129 | 1.07 | 18.58 | 3.270 | 1.15 | 1.24 |
| 2.999 | 0.000118 | 1.03 | 17.51 | 2.999 | 1.10 | 1.18 |
| 2.750 | 0.000108 | 0.99 | 16.48 | 2.750 | 1.06 | 1.13 |
| 2.522 | 0.000099 | 0.95 | 15.49 | 2.522 | 1.00 | 1.10 |
| 2.312 | 0.000091 | 0.92 | 14.54 | 2.312 | 0.96 | 1.06 |
| 2.121 | 0.000084 | 0.90 | 13.62 | 2.121 | 0.93 | 1.05 |
| 1.945 | 0.000077 | 0.89 | 12.72 | 1.945 | 0.91 | 1.05 |
| 1.783 | 0.000070 | 0.89 | 11.83 | 1.783 | 0.89 | 1.07 |
| 1.635 | 0.000064 | 0.90 | 10.94 | 1.635 | 0.90 | 1.09 |
| 1.499 | 0.000059 | 0.92 | 10.04 | 1.499 | 0.90 | 1.11 |
| 1.375 | 0.000054 | 0.92 | 9.12 | 1.375 | 0.89 | 1.12 |
| 1.261 | 0.000050 | 0.92 | 8.20 | 1.261 | 0.85 | 1.09 |
| 1.156 | 0.000046 | 0.90 | 7.28 | 1.156 | 0.80 | 1.04 |
| 1.060 | 0.000042 | 0.85 | 6.38 | 1.060 | 0.72 | 0.95 |
| 0.972 | 0.000038 | 0.78 | 5.53 | 0.972 | 0.64 | 0.84 |
| 0.892 | 0.000035 | 0.71 | 4.75 | 0.892 | 0.51 | 0.70 |
| 0.818 | 0.000032 | 0.62 | 4.04 | 0.818 | 0.33 | 0.52 |
| 0.750 | 0.000030 | 0.54 | 3.42 | 0.750 | 0.27 | 0.43 |
| 0.688 | 0.000027 | 0.46 | 2.88 | 0.688 | 0.22 | 0.35 |
| 0.630 | 0.000025 | 0.40 | 2.42 | 0.630 | 0.17 | 0.28 |
| 0.578 | 0.000023 | 0.35 | 2.02 | 0.578 | 0.14 | 0.23 |
| 0.530 | 0.000021 | 0.30 | 1.67 | 0.530 | 0.12 | 0.20 |
| 0.486 | 0.000019 | 0.27 | 1.37 | 0.486 | 0.10 | 0.18 |
| 0.446 | 0.000018 | 0.24 | 1.10 | 0.446 | 0.09 | 0.16 |
| 0.409 | 0.000016 | 0.23 | 0.86 | 0.409 | 0.19 | 0.22 |
| 0.375 | 0.000015 | 0.22 | 0.63 | 0.375 | 0.22 | 0.23 |
| 0.344 | 0.000014 | 0.24 | 0.41 | 0.344 | 0.21 | 0.19 |
| 0.315 | 0.000012 | 0.17 | 0.17 | 0.315 | 0.24 | 0.22 |
| 0.289 | 0.0000114 | 0.00 | 0.00 | 0.289 | 0.25 | 0.23 |
| 0.265 | 0.0000104 | 0.00 | 0.00 | 0.265 | 0.25 | 0.24 |
| 0.243 | 0.0000096 | 0.00 | 0.00 | 0.243 | 0.24 | 0.23 |
| 0.223 | 0.0000088 | 0.00 | 0.00 | 0.223 | 0.18 | 0.19 |
| 0.204 | 0.0000080 | 0.00 | 0.00 | 0.204 | 0.02 | 0.08 |
| 0.187 | 0.0000074 | 0.00 | 0.00 | 0.187 | 0.02 | 0.08 |
| 0.172 | 0.0000068 | 0.00 | 0.00 | 0.172 | 0.02 | 0.07 |
| 0.158 | 0.0000062 | 0.00 | 0.00 | 0.158 | 0.01 | 0.06 |
| 0.145 | 0.0000057 | 0.00 | 0.00 | 0.145 | 0.01 | 0.04 |
| 0.133 | 0.0000052 | 0.00 | 0.00 | 0.133 | 0.01 | 0.03 |
| 0.122 | 0.0000048 | 0.00 | 0.00 | 0.122 | 0.01 | 0.03 |
| | | | | 0.111 | 0.00 | 0.02 |
| | | | | 0.102 | 0.00 | 0.02 |
| | | | | 0.094 | 0.00 | 0.01 |
| | | | | 0.086 | 0.00 | 0.00 |
| | | | | 0.079 | 0.00 | 0.00 |
| | | | | 0.072 | 0.00 | 0.00 |
| | | | | 0.066 | 0.00 | 0.00 |
| | | | | 0.061 | 0.00 | 0.00 |
| | | | | 0.056 | 0.00 | 0.00 |
| | | | | 0.051 | 0.00 | 0.00 |
| | | | | 0.047 | 0.00 | 0.00 |
| | | | | 0.043 | 0.00 | 0.00 |
| | | | | 0.039 | 0.00 | 0.00 |
| | | | | 0.036 | 0.00 | 0.00 |
| | | | | 0.033 | 0.00 | 0.00 |
| | | | | 0.030 | 0.00 | 0.00 |
| | | | | 0.028 | 0.00 | 0.00 |
| | | | | 0.026 | 0.00 | 0.00 |
| | | | | 0.023 | 0.00 | 0.00 |

TABLE 4
Materials Characterization Analysis of Samples using XRF

| | | With Portland | | | | | |
|---|---|---|---|---|---|---|---|
| | | Blend A | Blend B | Blend C | | | Portland |
| XRF Results | Composition | A | B | C & D | Blend Min | Blend Max | Cement |
| CaO | | 57.1 | 57.1 | 56.2 | 56.2 | 57.1 | 62.9 |
| SiO2 | | 23.1 | 23.3 | 23.9 | 23.1 | 23.9 | 20.7 |
| Al2O3 | | 5.2 | 4.9 | 5.8 | 4.9 | 5.8 | 3.7 |
| Fe2O3 | | 3.5 | 3.5 | 3.3 | 3.3 | 3.5 | 3.0 |
| MgO | | 5.5 | 5.5 | 5.1 | 5.1 | 5.5 | 4.2 |
| SO3 | | 2.1 | 2.1 | 2.2 | 2.1 | 2.2 | 2.6 |
| Na2O | | 0.2 | 0.2 | 0.3 | 0.2 | 0.3 | 0.1 |
| K2O | | 0.5 | 0.5 | 0.6 | 0.5 | 0.6 | 0.6 |
| TiO2 | | 0.2 | 0.2 | 0.2 | 0.2 | 0.2 | 0.0 |
| P2O5 | | 0.0 | 0.0 | 0.0 | 0.0 | 0.0 | 0.0 |
| MnO | | 0.2 | 0.2 | 0.1 | 0.1 | 0.2 | 0.0 |
| Loss | | 2.4 | 2.4 | 2.4 | 2.4 | 2.4 | 2.7 |
| Total | | 100.06 | 99.99 | 100.19 | | | 100.50 |

| | | Without Portland | | | | |
|---|---|---|---|---|---|---|
| | | Blend A | Blend B | Blend C | | |
| XRF Results | Composition | A | B | C & D | Blend Min | Blend Max |
| CaO | | 33.8 | 33.9 | 29.6 | 29.6 | 33.9 |
| SiO2 | | 32.7 | 33.8 | 36.9 | 32.7 | 36.9 |
| Al2O3 | | 11.3 | 9.8 | 14.4 | 9.8 | 14.4 |
| Fe2O3 | | 5.3 | 5.3 | 4.6 | 4.6 | 5.3 |
| MgO | | 10.6 | 10.5 | 8.5 | 8.5 | 10.6 |
| SO3 | | 0.2 | 0.2 | 0.5 | 0.2 | 0.5 |
| Na2O | | 0.6 | 0.6 | 1.0 | 0.6 | 1.0 |
| K2O | | 0.3 | 0.3 | 0.7 | 0.3 | 0.7 |
| TiO2 | | 1.1 | 1.1 | 1.1 | 1.1 | 1.1 |
| P2O5 | | 0.0 | 0.0 | 0.0 | 0.0 | 0.0 |
| MnO | | 1.2 | 1.2 | 0.6 | 0.6 | 1.2 |
| Loss | | 1.1 | 1.2 | 1.1 | 1.1 | 1.2 |
| Total | | 98.28 | 97.95 | 98.97 | | |

TABLE 5
Materials Characterization Analysis of Samples using XRF, and XRD

| | | Stainless | | | | | | | | Ground | |
|---|---|---|---|---|---|---|---|---|---|---|---|
| | | Steel Slag | | Steel | | | | Type F | | Granulated | |
| | | Wt. % | | Making | | Silica | Type C | Fly Ash | | Blast Furnace | Portland |
| Formula | Compound | Min | Max | Slag | Metakaolin | Fume | Fly Ash | Min | Max | Slag | Cement |

| XRD Results | | | | | | | | | | | |
|---|---|---|---|---|---|---|---|---|---|---|---|
| | Amorphous | 27.6 | 50.5 | | 93.1 | 85.4 | 72.1 | 76.00 | 78.00 | 100 | 22.65 |
| Ca3Mg(SiO4)2 | marwinite | 13.3 | 21.1 | | | | 6.0 | | | | |
| Ca2SiO4 | calcio-olivine | 6.8 | 9.5 | | | | | | | | |
| CaCO3 | calcite | 2.4 | 6.3 | | | | | | | | |
| Ca2Mg(SiO7) | akermanite | 4.7 | 10.4 | | | | | | | | |
| CaMgSiO4 | monticellite | 3.3 | 6.8 | | | | | | | | |
| Ca2Al2SiO7 | gehtenite | 3.2 | 3.3 | | | | 3.6 | | | | |
| MgO | penclase | 3.0 | 4.4 | | | | | | | | |
| FeCr2O4 | chromite | 1.8 | 2.4 | | | | | | | | |
| Mg2SiO4 | forsterite | 1.4 | 2.7 | | | | | | | | |
| Ca4Al2Fe2O10 | brownmilterite | 1.6 | 2.8 | | | | | | | | |
| Fe | Iron | 0.4 | 0.5 | | | | | | | | |
| SiO2 | quartz | 0.1 | 0.4 | | | | 8.3 | 3.70 | 4.40 | | |
| Total | | | | | | | | | | | |
| XRF Results | | | | | | | | | | | |
| | CaO | 42.03 | 43.64 | 39.00 | 0.018 | 0.36 | 20.38 | 1.0 | 2.3 | 39.02 | 65.6 |
| | SiO2 | 25.33 | 27.68 | 12.90 | 52.06 | 97.95 | 41.63 | 45.8 | 56.3 | 34.28 | 19.38 |
| | MgO | 13.33 | 13.84 | 7.43 | 0.02 | 0.22 | 4.99 | 0.8 | 0.9 | 11.39 | 1.26 |
| | Al2O3 | 5.73 | 6.84 | 4.23 | 45.26 | 0.31 | 20.88 | 22.6 | 26.1 | 10.01 | 5.66 |
| | Fe2O3 | 4.92 | 6.07 | 24.90 | 0.46 | 0.3 | 6.10 | 9.3 | 19.4 | 0.45 | 3.14 |
| | Cr2O3 | 1.85 | 2.66 | 0.87 | 0.0 | | | 0.0 | | 0.01 | |
| | MnO | 1.21 | 1.73 | 3.97 | 0.01 | 0.04 | 0.03 | 0.02 | 0.04 | 0.6 | 0.15 |
| | TiO2 | 0.79 | 1.05 | 1.05 | 1.73 | 0.01 | 1.300 | 1.1 | 1.5 | 0.64 | 0.38 |
| | SO3 | 0.16 | 0.38 | 0.23 | 0.021 | | 0.680 | 0.7 | 0.7 | | 3.18 |
| | ZrO2 | 0.10 | 0.13 | | | | 0.07 | 0.0 | 0.0 | 0.04 | 0.016 |
| | Na2O | 0.08 | 0.08 | >0.10 | 0.22 | 0.16 | 1.84 | 0.3 | 0.6 | 0.3 | 0.07 |
| | P2O5 | 0.03 | 0.10 | 0.25 | 0.045 | | 1.030 | 0.1 | 0.3 | 0.01 | 0.17 |
| | K2O | 0.02 | 0.11 | 0.02 | 0.12 | 0.65 | 1.090 | 1.8 | 2.4 | 0.4 | 0.81 |

| | | | | | | | | | |
|---|---|---|---|---|---|---|---|---|---|
| Total | | | | | | | | | |
| FAS Calculation | 35.98 | 40.59 | 42.03 | 97.78 | 98.56 | 68.61 | 77.77 | 101.68 | 44.74 |
| Iron, Aluminum, and Silicon | | | | | | | | | |

TABLE 6
Bogue Calculations

| | Portland | | |
|---|---|---|---|
| | Cement | CP | RM |
| C3S = | 69.56% | 16.82% | 20.29% |
| C2S = | 6.96% | 53.62% | 50.75% |
| C3A = | 4.73% | 7.96% | 7.94% |
| C4AF = | 9.13% | 10.56% | 9.94% |

| | Slag | GGBFS | C Ash | F Ash | Silica Fume | Metakaolin |
|---|---|---|---|---|---|---|
| C3S = | 40.16% | 21.72% | −20.86% | −44.92% | −73.74% | −84.45% |
| C2S = | 32.50% | 50.82% | 87.18% | 107.73% | 152.67% | 141.11% |
| C3A = | 5.03% | 8.94% | 12.79% | 12.88% | 3.78% | 27.62% |
| C4AF = | 10.59% | 7.58% | 11.02% | 12.48% | 7.49% | 7.58% |

We claim:

1. A supplementary cementitious material comprising:
about 25% to about 80% of slag, by weight, about 20% to about 75% other pozzolans, and about 0% to about 25% other additives.

2. The supplementary cementitious material of claim 1, wherein said other pozzolans are selected from the group consisting of silica fume, metakaolin, Class C fly ash, Class F fly ash, Class N pozzolan, rice hull ash, silica flour, and ground granulated blast furnace slag.

3. The supplementary cementitious material of claim 2, wherein silica fume is present in an amount between 0.0 and 20% by weight, metakaolin is present in an amount between 0.0 to 20% by weight, Class C fly ash is present in an amount between 0.0 to 60% by weight, Class F fly ash is present in an amount between 0.0 to 60% by weight, Class N pozzolan is present in an amount between 0.0 to 60% by weight, ground granulated blast furnace slag in an amount between 0.0 to 60% by weight, rice hull ash in an amount between 0.0 to 60% by weight, and silica flour in an amount between 0.0 to 20% by weight.

4. The supplementary cementitious material of claim 1, wherein said slag is selected from the group consisting of alloy steel slag and steel slag.

5. The supplementary cementitious material of claim 4, wherein said slag is stainless steel slag.

6. The supplementary cementitious material of claim 1 wherein said slag has a metal content less than about 10%.

7. The supplementary cementitious material of claim 1, wherein said slag has between about 20% and about 50% amorphous content as measured by X-ray diffraction.

8. The supplementary cementitious material of claim 1, wherein at least 20% of said material has a particle size greater than 68 μm and less than 420 μm.

9. The supplementary cementitious material of claim 1, further comprising at least one member of the group consisting of calcium oxide and calcium hydroxide.

10. A cement composition comprising about 5 to 50% of the supplementary cementitious material of claim 1 and about 50% to about 90% of portland cement.

11. A supplementary cementitious material comprising slag, wherein at least 22% of said material has a particle size greater than 68 μm and less than 420 μm.

12. The supplementary cementitious material of claim 11, wherein at least 16% of said material has a particle size greater than 80 μm and less than 418 μm.

13. The supplementary cementitious material of claim 11, wherein at least 14% of said material has a particle size greater than 90 μm and less than 418 μm.

14. The supplementary cementitious material of claim 11, wherein said composition further comprises at least one member of the group consisting of Class C fly ash, Class F fly ash, Class N pozzolan, rice hull ash, silica flour, ground granulated blast furnace slag, calcium oxide, silica fume, and metakaolin.

15. The supplementary cementitious material of claim 11, wherein said slag is selected from steel slag and alloy steel slag.

16. The supplementary cementitious material of claim 11, wherein said slag is stainless steel slag.

17. The supplementary cementitious material of claim 11, wherein said stainless steel slag has a metal content less than about 10%.

18. The supplementary cementitious material of claim 11, wherein said slag has between about 20% and about 50% amorphous content as measured by X-ray diffraction.

19. A supplementary cementitious material comprising slag and at least one other pozzolan, wherein said slag has between about 40% and about 90% amorphous content as measured by X-ray diffraction.

20. The composition of claim 19, wherein said slag has between about 40% to about 70% amorphous content as measured by X-ray diffraction.
